(19) United States
(12) Patent Application Publication
(10) Pub. No.: US 2016/0002446 A1
(43) Pub. Date: Jan. 7, 2016

(54) RUBBER BLEND COMPOSITION WITH REDUCED INTERNAL FRICTION

(71) Applicant: Gerhard KARALL, Neunkirchen (AT)

(72) Inventor: Gerhard KARALL, Neunkirchen (AT)

(21) Appl. No.: 14/769,948

(22) PCT Filed: Mar. 3, 2014
(86) PCT No.: PCT/AT2014/050049

§ 371 Date: Aug. 24, 2015

(30) Foreign Application Priority Data
Mar. 6, 2013 (AT) A 50153/2013

(51) Int. Cl. C08K 9/02; C08K 3/00; C08C 19/00; C08K 5/00; C08K 3/04

(52) U.S. Cl. CPC C08K 9/02; C08K 5/0008; C08K 3/04; C08C 19/00; C08K 3/0008; C08K 2003/045

(57) ABSTRACT

The invention relates to a rubber blend composition with reduced internal friction, especially for tyres and transmission systems. In order to reduce the internal friction, trans-polynorbornenes are used at least partly together with process oils or resins with a glass transition of <−20° C. for the rubber blend composition.

### FIELD OF THE INVENTION

The invention relates to a vulcanised rubber blend composition with reduced internal friction, especially for tyres and transmission systems such as belts, bands and the like.

### DESCRIPTION OF THE PRIOR ART

E-SBR, S-SBR, natural rubber, butadiene rubber and/or liquid forms of the aforementioned rubbers are used as a polymer base for tyre treads currently available on the market. Active fillers such as silicic acid, with or without silanization, are added to the polymer base for improving rolling resistance. The properties are improved even further by special vulcanisation systems.

Furthermore, the tyre width, the air pressure and the profile configuration have a relevant influence on the rolling resistance of a tyre. Comparable blend configurations are used in the field of transmission systems, which are partly fibre-reinforced, as well as for tyres.

There is currently an increasing need for tyres with improved driving behaviour in combination with the lowest possible rolling resistance, which is substantially determined by the rubber blend of the tread, the tyre pressure, the tyre width and the tread profile.

A tyre should have the highest possible coefficient of friction between the tread and the road surface, and should offer low wear and tear in use and low rolling resistance.

The coefficient of friction between the tread and the road surface is in relation to the loss factor (tan delta) of the rubber blend of the tread. The context applies in known rubber blend compositions that the coefficient of friction is the higher the greater tan delta. Tan delta is further dependent on the temperature and the rolling speed. In addition to other factors of influence, the grip of a tyre also varies for this reason depending on the ambient temperature and the travelled speed.

### SUMMARY OF THE INVENTION

The invention is thus based on the object of providing a rubber blend composition which offers reduced rolling resistance, mainly for the treads of tyres, and for transmission systems such as transport belts, V-belts, etc. In addition, good abrasive properties in use and good grip shall be achievable.

This object is achieved by the invention by using trans-polynorbornenes together with process oils or resins having a glass transition of <−20° C.

The rubber blend composition in accordance with the invention has a considerably reduced loss factor, which means a lower rolling resistance for a tyre produced from said composition, which thus allows reducing fuel consumption. The reduced internal friction produces a lower heating of the tyre in operation and improved efficiency. Furthermore, the rubber blend composition offers better abrasion properties, e.g. 50 mm³ DIN abrasion, in comparison with conventional rubber blends. A coefficient of friction of 0.8 between the rubber blend and steel under dry conditions can be achieved with the rubber blend composition in accordance with the invention, as a result of which a tyre grip can be achieved which is comparable with commercial racing tyres. The rubber blend composition in accordance with the invention can be used both as a tread surface and also as flank material. The rubber tread blend is built up on the basis of trans-polynorbornenes and is processed or vulcanised in conventional processing methods.

A further application is the use in transmission systems for improving the efficiency of belt systems.

It is recommended for using the rubber blend composition in our latitudes that the process oil is a paraffinic oil with a glass transition of <−20° C., preferably ≦−70° C.

Silanized silicic acid and carbon black are recommended as additives or fillers.

The rubber blend composition comprises trans-polynorbornenes together with process oils at a ratio of 1:0.1 to 1:5, preferably at a ratio of 1:1. Furthermore, the rubber blend can be used alone per se, or also together with conventional elastomer mixtures as a blend or in combination (with a layered configuration).

### BRIEF DESCRIPTION OF THE DRAWINGS

The subject matter of the invention is shown by way of example in the drawings, wherein:

FIG. 1 shows a diagram with the loss factor [tan delta] over the temperature for a sample of a rubber blend according to the prior art, and

FIG. 2 shows a diagram with the loss factor [tan delta] over the temperature for a sample of a rubber blend according to the invention.

### DESCRIPTION OF THE PREFERRED EMBODIMENT

The samples are arranged in a cuboid manner with the dimensions 10×3.2×20.2 mm. The sample in accordance with the invention consists of a rubber blend composition in accordance with the invention with reduced internal friction, which composition was fully vulcanised and consists of trans-polynorbornenes and a process oil with a glass transition of <−70° C. and silanized silicic acid.

For the purpose of achieving these advantages, the special polymer Norsorex NS (trans-polynorbornene of Astrotech) is combined with process oils with a glass transition temperature of less than minus 70 degrees Celsius (paraffinic oil 1998 of H&R) at a ratio of 1:1 and the known techniques, the adding of silanized silicic acid and the use of optimised vulcanisation systems are applied.

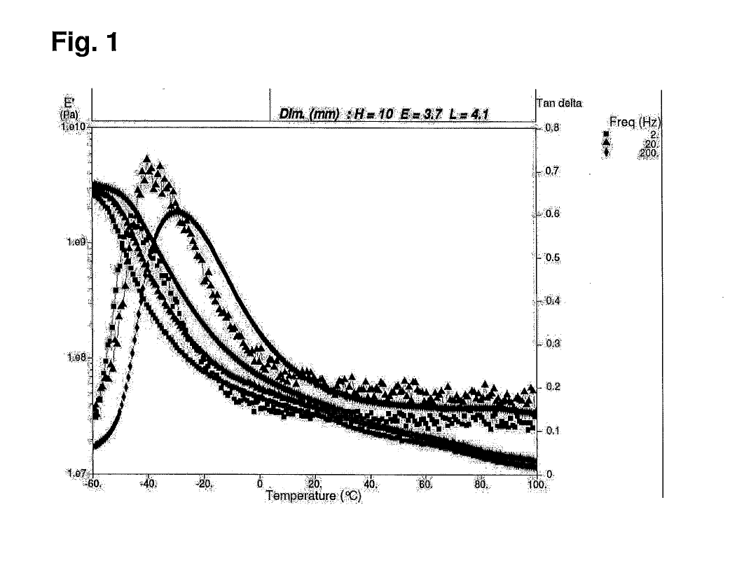

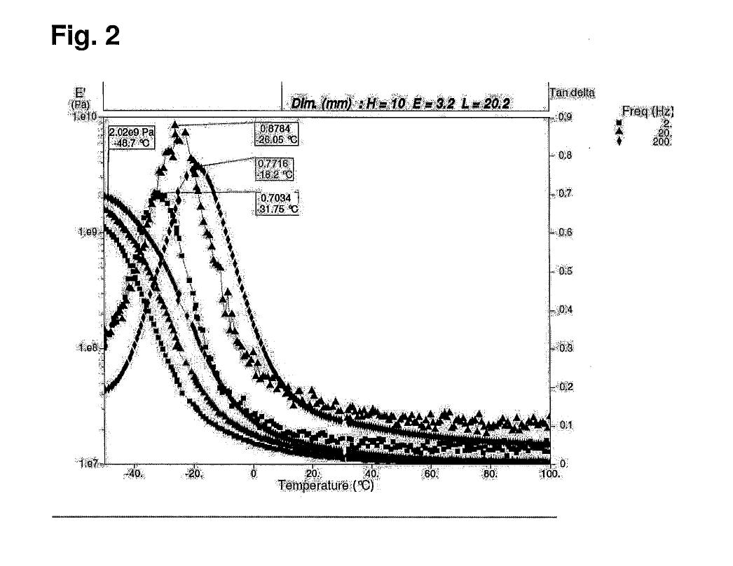

The rubber blend composition shown in the drawings according to FIG. 1, i.e. a conventional tyre blend according to the prior art, and a blend according to the invention as shown in FIG. 2, show a significant difference in the level of the loss factor [tan delta] in the operating temperature range of between 20 to 60° C. In particular, a known rubber blend composition shows a tan delta of 0.12 to 0.19 and a DIN abrasion of 117 mm³, whereas the rubber blend composition in accordance with the invention shows a tan delta of 0.03 to 0.11 and a DIN abrasion of 51 mm³. The measurement occurred at different frequencies at 2, 20 and 200 Hz. The coefficient of friction on steel is 0.8 under dry conditions.

The modulus of elasticity is entered on the left vertical axis of the diagrams. It is used for evaluating where the material has its glass transition and collapses by approximately three powers of ten in the modulus, and at which level the modulus of elasticity comes to lie in the in-use temperatures range.

1. A rubber blend composition with reduced internal friction, especially for tires and transmission systems, comprising the use of trans-polynorbornenes together with process oils or resins with a glass transition of <−20° C.

2. A rubber blend composition according to claim 1, wherein the process oil is paraffinic oil with a glass transition of <−20° C., preferably ≦−70° C.

3. A rubber blend composition according to claim 1, comprising the use of silanized silicic acid as a filler.

4. A rubber blend composition according to claim 1, comprising adding carbon black as a filler.

5. A rubber blend composition according to claim 1, wherein it is vulcanized.

6. A rubber blend composition according to claim 1, comprising the use of trans-polynorbornenes together with process oils at a ratio of 1:0.1 to 1:5, preferably at a ratio of 1:1.

7. A rubber blend composition according to claim 1, comprising the addition to conventional elastomer blends.
